(19) United States
(12) Patent Application Publication
(10) Pub. No.: US 2009/0216579 A1
(43) Pub. Date: Aug. 27, 2009

(54) TRACKING ONLINE ADVERTISING USING PAYMENT SERVICES

(75) Inventors: Lee-Ming Zen, Manhattan, NY (US); Zack Hilton, Allison Park, PA (US); Trevor Norrington, Brooklyn, NY (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 12/036,018

(22) Filed: Feb. 22, 2008

(51) Int. Cl. G06Q 10/00

(52) U.S. Cl. 705/7; 705/14

(57) ABSTRACT

A user's online activity is tracked and offers associated with online advertisements presented to the user are identified. Information regarding these offers are provided to a payment service, which associates the information with an account for the user. When the user performs an activity using a payment card or other payment mechanism, the payment service may identify the activity as corresponding with an offer. Information regarding the completion of the activity for the offer may then be associated with information regarding the user's online activity. Additionally, a rebate and/or incentive may be provided to the user based on completion of the activity.

### BACKGROUND

Online advertising has become a significant aspect of computing environments, as it presents a powerful way for advertisers to market their products and services. For instance, online advertising is often more likely to allow advertisers to effectively deliver advertisements to their target audiences as compared with traditional media advertising, such as newspapers, magazines, and radio. Additionally, there are a variety of advertisement systems and methods for delivering online advertisements for presentation to users. Generally, online advertising includes any form of advertising that uses computer network environments to deliver advertisements and other marketing messages to potential customers. For instance, advertisements may be presented within web pages, search engine search results, online video games, advertisement-based software applications, and email messages, to name a few. A wide variety of additional approaches and environments exist for delivering online advertising for presentation to users.

Despite the advantages of online advertising, tracking the effectiveness of online advertisements, especially in the offline setting, has proven to be difficult. Although in some cases users may purchase products and services online (thereby allowing the online advertising and purchasing to be more easily correlated), determining that online advertising is effective when users purchase products and services offline is more challenging. For example, a user might search for a digital camera online, look at a variety of online advertisements, perform research online, but then decide to buy the camera offline, for instance, at a “brick and mortar” store. In such a situation, it is difficult to link the offline purchase to the online activity and the online advertisements that led to the purchase. Even in an online setting, a user may purchase a product or service separate from an online advertisement that may have led to the purchase, making it difficult to attribute that purchase to the online advertisement.

Additionally, advertisers often wish to provide offers, such as rebates and incentives, to persuade potential customers to purchase their products and services. However, it has proven difficult to provide such offers to users from online advertisements when users purchase the goods or services offline. One approach is to provide a coupon via an online advertisement that the user can print and use at an offline location. For example, a user may view an online advertisement for a digital camera that includes a rebate coupon. The user may print and bring the coupon to an offline store to obtain the rebate when purchasing the camera. However, users may find this approach cumbersome as users must print the coupon and bring the coupon to the store. Additionally, when advertisers wish to provide incentives rather than rebates (e.g., frequent flyer miles, reward points, etc.), it is more difficult to provide such incentives to users when the users make offline purchases.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention relate to, among other things, using a payment service to identify completion of activities associated with offers extended to users through online advertising. Online activity of a user is tracked, and offers associated with advertisements presented to the user are identified. The offers generally include rebates and/or incentives extended to the user in exchange for the user performing a desired activity, such as purchasing an advertiser's product or service. Information regarding the offer (and, in some cases, the online activity generally) is stored. Additionally, information regarding the offer is communicated to a payment service that facilitates payment using payment cards, such as credit cards and debit cards, for instance, or other payment mechanisms. Through transactions performed by the user using the user's payment card or other payment mechanism, the payment service identifies when the user has performed the activity associated with the offer. In some embodiments, information regarding completion of the activity is associated with the information regarding the offer and/or the user's online activities. Additionally, in some embodiments, the rebate and/or incentive for the offer is provided to the user based on completion of the desired activity.

### BRIEF DESCRIPTION OF THE DRAWINGS

The present invention is described in detail below with reference to the attached drawing figures, wherein:

FIG. 1 is a block diagram of an exemplary computing environment suitable for use in implementing the present invention;

FIG. 2 is a block diagram of an exemplary system in which embodiments of the present invention may be employed;

FIG. 3 is a block diagram showing an overall operation of a service for tracking online activity and offline activity for offers provided by online advertisements in accordance with an embodiment of the present invention;

FIG. 4 is flow diagram showing a method for tracking a user's online activity and providing information regarding the online activity to a payment service in accordance with an embodiment of the present invention;

FIG. 5 is flow diagram showing a method for receiving offer information for a user at a payment service and identifying the occurrence of user activity that is associated with the offer in accordance with an embodiment of the present invention; and

FIG. 6 is flow diagram showing a method for receiving information regarding activity completed for an offer and associating the offer activity information with online activity information in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention relate to, among other things, tracking offers provided to users via online advertising and using payment services networks to facilitate recognizing that users have completed activities such that the users should be provided a rebate or incentive associated with the offers. As such, embodiments provide a service that allows users to redeem incentives and rebates from online advertisements when performing activities using payment cards or other payment mechanisms, including offline activities such as purchasing products or services from a “brick and mortar” store. Additionally, embodiments allow purchasing and other activity, including offline activity, to be identified and associated with the online activity that led to the purchase or other activity, thereby allowing the effectiveness of online advertising to be more accurately realized.

In accordance with embodiments of the present invention, online advertisements may be delivered to a user in a variety of different online environments. Generally, as used herein, “online advertisements” include any form of advertising delivered to users through network environments, such as the Internet. For instance, advertisements may be presented on web pages viewed while web browsing, with search results returned from search queries, within advertisement-based software applications, within video gaming applications, within instant messaging applications, and within email messages.

The user's interaction with the online advertisements is tracked by a tracking service, which may track information such as advertisements viewed by the user, the number of times a user has viewed a particular advertisement, whether a user has hovered over an advertisement, and/or whether a user has selected an advertisement. In some embodiments, the tracking service may also track additional information regarding the user's online activity beyond interaction with online advertisements. For instance, the tracking service may track information such as web pages viewed by the user, search queries submitted by the user, and search results selected by a user. Generally, as used herein, “online activity” refers to any type of computing activity that includes some interaction with a network environment. Although online activity often includes computing activity that occurs while the user's computing device is connected to the networked environment (e.g., “online”), in some cases, computing activity that occurs while the user's computing device is not connected to the network environment (e.g., “offline”) may be considered as online activity. For instance, advertisements may be delivered to and cached by a user's computing device while the device is online. However, the user may interact with the advertisements while the computing device is offline, and information regarding such interaction may be communicated to the network environment when the computing device is again online.

In some cases, an advertisement delivered to the user may have an associated offer for a user to redeem an incentive or rebate. As used herein, the term “offer” generally refers to any type of compensation or remuneration that induces a user to perform some activity desired by an advertiser. For example, in some instances, an offer may include a rebate for purchasing a product or service. In other instances, an offer may include an incentive other than a rebate, such as frequent flyer miles or reward points that may be redeemed by the user. The desired activity may include purchasing a product or service or may include performing some other activity that does not include a purchase, such as test driving an automobile, for instance. In embodiments, the activity includes “offline activity,” including activity performed separate from an online computing environment in which the user performs online activity using the user's computing device. Although embodiments herein are discussed primarily in the context of a user performing offline activity corresponding with an offer, some embodiments are directed to situations in which the activity is an “online activity,” such as a user employing a payment card to purchase a product or service online.

When the tracking service or an associated service identifies an advertisement that has an associated offer, information regarding the user and the offer is communicated to a payment service used by the user. As used herein, a “payment service” includes any system that facilitates payment for products and/or services. In some embodiments, a payment service may be a system that facilitates payment using payment cards, such as credit cards and debit cards, for instance. By way of example and not limitation, a payment service may be provided by a credit card company or a bank. In other embodiments, payment services may include systems that facilitate payment using other types of payment mechanisms. For instance, a payment service may employ an SMS (short message service) payment mechanism. As another example, checking may be employed as a payment mechanism by a payment service provided, for instance, by a bank.

The payment service associates information regarding the offer with the user's account. Accordingly, when a user performs an activity using their payment card or other payment mechanism, the payment service receives information regarding the activity. As noted above, in some embodiments, the activity may be an offline activity, such as a user purchasing a product at a “brick and mortar” store using a payment card or other payment mechanism, while in other embodiments the activity may be an online activity, such as a user purchasing a product or service on the Internet using a payment card or other payment mechanism. In both embodiments, completion of an activity associated with an offer is recognized using a payment service.

The payment service may identify the offer associated with the activity. By recognizing that an activity for an offer has been completed, the rebate and/or incentive for the offer may be provided to the user based on the completion of that activity. In some embodiments, the payment service may also provide information regarding the activity to the tracking service or an associated service, which associates the activity with the online activity.

Accordingly, embodiments of the present invention provide a convenient and seamless approach that allows users to receive rebates and/or incentives from online offers automatically when the users employ their payment cards or other payment mechanisms to perform activities associated with the online offers. Users are not required to print coupons or perform other acts to receive the rebates and/or incentives other than using their payment cards or other payment mechanisms as they normally would. Additionally, by associating information regarding activities performed by users with online activity, embodiments facilitate recognizing the effectiveness of online advertising. This is particularly useful when the activities are offline activities that have proven difficult to track. As such, the extent to which online advertising is the source of users' purchases and other activities desired by advertisers (as opposed to other forms of advertising) may be more accurately determined.

Based on information collected in accordance with embodiments of the present invention, advertisers may determine how to better allocate their marketing budget. For instance, advertisers may make larger or smaller investments for online advertising depending upon the determined effectiveness of their online advertising campaigns. Additionally, if an advertiser has multiple online advertisements and the service described herein collects detailed information, the advertiser may determine which advertisements were more likely to lead to purchases and/or other desired user activities. Further, the information may allow advertisers to determine which online environments (e.g., specific web sites, etc.) were the most effective.

Accordingly, in one aspect, an embodiment of the present invention is directed to one or more computer-storage media having computer-useable instructions embodied thereon for performing a method. The method includes tracking online activity for a user and identifying (404) an offer associated with an advertisement presented during the online activity. The offer extends a rebate and/or an incentive to the user in exchange for the user performing a desired activity. The method also includes storing information regarding the offer and sending information regarding the user and the offer to a payment service. The method further includes receiving information from the payment service regarding performance of the desired activity by the user. The method still further includes associating the information regarding performance of the desired activity by the user with the information regarding the offer.

In another aspect of the invention, an embodiment is directed to one or more computer-storage media having computer-useable instructions embodied thereon for performing a method. The method includes receiving information identifying the user and an offer associated with an advertisement presented to the user during online activity of the user. The information identifying the user and the offer being is received at a payment service. The offer extends at least one of a rebate and an incentive to the user in exchange for the user performing a desired activity. The method also includes identifying performance of the desired activity associated with the offer. The performance of the desired activity includes use of a payment mechanism associated with the payment service.

In a further embodiment, an aspect of the invention is directed to a computerized system that includes one or more servers for tracking online activity for a user to identify an offer associated with an advertisement presented to the user. The offer extends a rebate or an incentive to the user in exchange for the user performing a desired activity. The one or more servers store information regarding the online activity including the offer. The one or more servers also communicate information regarding the user and the offer to a payment service that facilitates payments using payment cards. The payment service identifies offline activity performed by the user using a payment card that corresponds with the desired activity and communicates information regarding the offline activity to the one or more servers. The one or more servers associate the information regarding the offline activity with the information regarding the online activity.

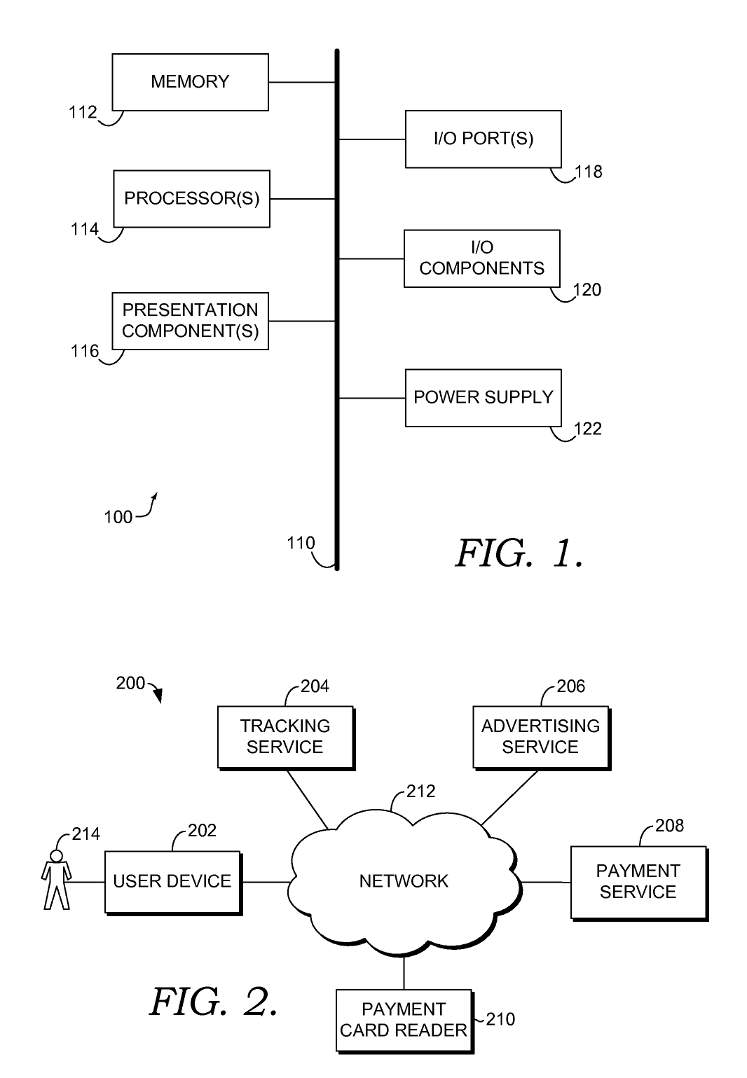

Having described an overview of the present invention, an exemplary operating environment in which various aspects of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

Referring now to FIG. 2, a block diagram is shown of an exemplary system 200 in which exemplary embodiments of the present invention may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

As shown in FIG. 2, the system 200 includes, among other components not shown, a user device 202, a tracking service 204, an advertising service 206, a payment service 208, and a payment card reader 210. Each of the components and services shown in FIG. 2 may be and/or include any type of computing device, such as computing device 100 described with reference to FIG. 1, for example. It should be understood that any number of user devices, tracking services, advertising services, payment services, and payment card readers may be employed within the system 200 within the scope of embodiments of the present invention. Additionally, other components not shown may also be included within the system 200.

The components within the system 200 may communicate with each other via a network 212, which may include one or more wide area networks (WANs) and/or one or more local area networks (LANs), as well as one or more public networks, such as the Internet, and/or one or more private networks. Such networking environments are commonplace in offices, enterprise-wide computer networks, intranets, and the Internet. For instance, the network 212 may include one or more networks providing network services, such as those discussed herein. Packets may be routed in and among the network 212 using protocols, such as the Internet Protocol (IP), and devices in communication within and among the network 212 may be identified by a network address, such as an IP address. Further, the network 212 may include a number of circuit-switched networks, such as the public-switched telephone network (PSTN), for example. Additionally, the network 212 may include one or more transactions networks for implementing electronic payment transactions for payment services.

Generally, the system 200 of FIG. 2 provides services to a user 214 that include identifying offers corresponding with advertisements presented to the user 214 during online activity and associating the offers to the user's account with a payment service, such as the payment service 208. Accordingly, the user 212 may receive a rebate or an incentive when the user 212 performs an activity (including an offline activity) corresponding with an offer by using a payment card or other payment mechanism associated with the payment service.

The advertising service 206 may include one or more servers or other computing devices that may be employed to deliver advertisements to user devices, such as the user device 202. In some embodiments, the advertising service 206 may be provided by an advertising service provider. Although only a single advertising service 206 is shown in FIG. 2, the system 200 may include any number of advertising services that may be provided by one or more advertising service providers. Additionally, those skilled in the art will recognize that advertising services may select and deliver advertisements to user devices, such as the user device 202, in a number of different manners. For instance, the advertising service 206 may provide advertisements for placement on web pages that may be requested by and viewed on the user device 202. Additionally, the advertising service 206 may provide advertisements for presentation with search results from a search engine. Additionally, the advertising service 206 may deliver advertisements to a client application residing on the user device 202, such as an advertisement-based software application, a gaming application, or an instant messaging application, for instance. Additionally, the advertising service 206 may provided contextual-based advertisements and/or advertisements targeted to the user 214 based on any available information describing the user 214.

The tracking service 204 may include one or more servers or other computing devices that may be employed to track online activity for user devices, such as the user device 202. The tracking service 204 may be provided by a tracking service provider. In some embodiments, the tracking service provider and advertising service provider providing the advertising service 206 may be a single entity, while in other embodiments they are separate entities. Although only a single tracking service 204 is shown in FIG. 2, the system 200 may include any number of tracking services 204 that may be provided by one or more tracking service providers.

In embodiments, the tracking service 204 tracks user interactions with advertisements. For instance, the tracking service 204 may track interaction with advertisements delivered to the user device 202 from the advertising service 204. The interaction may include, for instance, advertisements presented by the user device 202, a number of times a particular advertisement has been presented by the user device 202, whether a user has hovered over a presented advertisement (e.g., by using a pointing device to place a cursor over the advertisement), and/or whether a user has selected a presented advertisement (e.g., by using pointing device to select the advertisement). In further embodiments, the tracking service 204 may also track online activity other than user interactions with advertisements. For instance, the tracking service 204 may track information such as web pages viewed by a user during web browsing, search queries submitted to a search engine, and search results selected by a user.

Those skilled in the art will recognize that a variety of techniques may be employed for tracking online activities of user devices, such as the user device 202. For instance, the tracking server 204 may employ cookies to track online activities for the user device 202. In some embodiments, a client application may reside on the user device 202 to track activities and to communicate information regarding those activities to the tracking server 204. In general, any mechanisms now known or later developed for tracking online activities of the user device 202 may be employed within the scope of embodiments of the present invention.

Information regarding a user's online activity may be stored. In various embodiments, the information regarding the online activity may be stored by the tracking service 204, the advertising service 206, and/or another service. The information stored may include information regarding user interactions with advertisements and/or information regarding other online activity. Additionally, offers associated with advertisements presented to the user are identified, and information regarding such offers is communicated to the payment service 208. In various embodiments of the invention, the tracking service 204, advertising service 206, and/or another associated service may identify offers associated with the advertisements and communicate offer information to the payment service 208.

The payment service 208 generally may include one or more servers or other computing devices that facilitate payments for user purchases using payment cards, such as credit cards and debit cards, for instance, or other payment mechanisms. The payment service 208 may be provided by a payment service provider, such as a credit card company or a bank, for instance, that is typically separate from the advertising service provider and/or tracking service provider. Although only a single payment service 208 is shown in FIG. 2, the system 200 may include any number of payment services provided by one or more payment service providers.

The payment service 208 receives offer information from the tacking service 204, advertisement service 206, and/or other associated service and associates the information with a user account for the user 212. By associating the offer information with the user account, when activity corresponding with the offer is performed by the user 212 using a payment card or other payment mechanism, the activity may be identified as corresponding with the offer. For instance, the user 212 may visit a retail store or other offline location and perform some offline activity, such as making a purchase. The user's payment card is read by a payment card reader 210 at the offline location, and information is transmitted to the payment service 208, for example, though a transaction network facilitating electronic payment transactions.

In some embodiments, the payment service 208 may communicate information regarding the activity completed for an offer to the tracking service 204, advertisement service 206, and/or other associated service, which may associate the offer activity with the online activity. The information regarding the offer activity may simply indicate that a required activity for an offer has been completed or may include more detailed information regarding the activity, such as, for instance, products or services purchased, price paid, purchase location, and time/date of a transaction.

Upon completing activity for a given offer, the user 212 may be provided a rebate or incentive for the offer. The rebate or incentive may be provided to the user 212 in a variety of different manners within the scope of embodiments of the present invention. For instance, in one embodiment in which the offer includes a rebate, the payment service 208 may provide a credit to the user's account or the payment price may be reduced at the time of the purchase. In another embodiment, the payment service 208 may provide some form of incentive such as reward points that may be redeemed by the user 212. In further embodiments, the tracking service 204, advertising service 206, and/or other associated service may facilitate providing a reward or incentive to the user 212 based on information received from the payment service. For instance, the tracking service 204, advertising service 206, and/or other associated service could provide reward points that may be redeemed by the user 212 or could provide a rebate check. In some cases, the advertiser associated with the offer may compensative the tracking service 204, advertising service 206, payment service 208, and/or other associated service for providing the rebate or incentive to the user 212. In some embodiments, the tracking service 204, advertising service 206, payment service 208, and/or other associated service may provide information to an advertiser associated with an offer, who may then provide the rebate or incentive to the user 212. Any and all such variations are contemplated to be within the scope of embodiments of the present invention.

In some embodiments, the user 214 may be required to sign-up for the services provided by the system 200 of FIG. 2. Generally, the user 214 may sign up for such services at any time, such as when web browsing, when clicking on an advertisement, or when the user 214 learns of the service. Additionally, the user 214 may sign up for such services in a number of different manners within embodiments of the present invention. For instance, the user 214 may sign up using a secure website provided by the tracking service provider and/or the payment service provider. In some embodiments, for security and privacy purposes, it may be preferable to require the user 214 to sign up for the service at a secure website provided by the payment service provider and to prevent the user 214 from having to provide any payment card account information to the tracking service 204 or another service. A unique identifier may be assigned to the user 214 by the tracking service 204, the payment service 208, or another associated service and may be used when tracking a user's online activity and/or when communicating information between the various services. The only information the tracking service 204, advertisement service 206, and/or other associated service may need regarding the user's payment service account would be the particular payment service(s) with which the user 214 has an account. For instance, in some embodiments, the tracking service 204 or other associated service may partner with multiple different payment services. In such embodiments, the tracking service 204 may need information identifying which payment service(s) with which the user 214 has a payment service account so that the tracking service may route offer information for the user 214 to the proper payment service(s). Additionally, the user 214 may have accounts with multiple payment services and may wish to employ more than one of those payment services for the services discussed herein. Accordingly, the user 214 could have multiple payment services eligible to redeem a given offer in some embodiments of the present invention. In other embodiments in which the tracking service 204 and/or advertising service 206 partners with only one payment service 208, such identification of the payment service 208 would not be required.

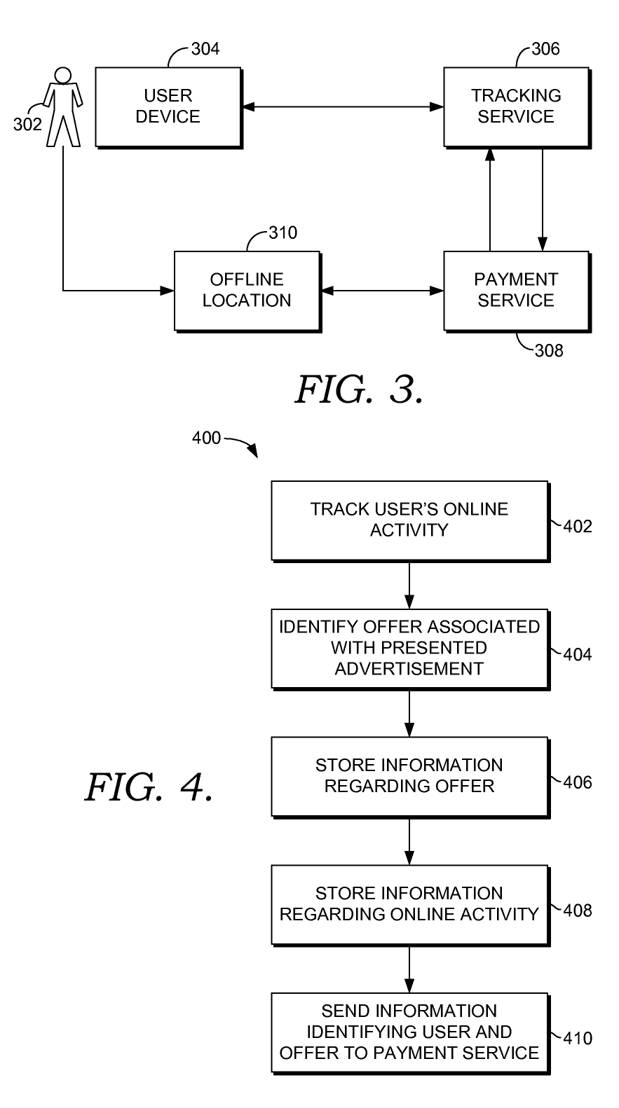

A block diagram illustrating one specific operation of a service for tracking online activity and offline activity for offers provided by online advertisements in accordance with an embodiment of the present invention is provided in FIG. 3. Although FIG. 3 and the corresponding discussion below are directed to an embodiment in which a user 302 completes activity for an offer in an offline setting, as noted previously, embodiments of the present invention include a user completing an activity for an offer in an online setting. Additionally, although FIG. 3 and the corresponding discussion below describe an embodiment with specific interactions between a tracking service 306 and payment service 308, other embodiments may include use of other services for tracking and associating online and offline activity.

As shown in FIG. 3, a tracking service 306 tracks online activity of a user 302 employing a user device 304. The tracking service 306 may track information including user interactions with advertisements delivered to the user device 304, and, in some cases, information regarding other online activity, such as web browsing, searching, and other online activities. In some embodiments, the tracking service 306 stores information regarding the online activity.

The tracking service 306 identifies offers associated with online advertisements delivered to the user device 304, and communications information regarding the offers to a payment service 308. The information communicated between the tracking service 306 and the payment service 308 may include information identifying the user 302, and information identifying particular offers extended to the user 302. Using the user identifying information, the payment service 308 may associate the offer information with a user account for the user 302.

When the user 302 performs some activity at an offline location 310, the user's payment card may be read by a payment card reader at the offline location 310. For instance, the user 302 may purchase a product or service using their payment card. In some cases, the offline activity may not include a purchase. For example, an offer may provide an incentive to test drive an automobile. When the user 302 completes the test drive, the user's payment card may be read by a payment card reader to indicate that the test drive has been completed, although no payment transaction is performed. As indicated previously, embodiments of the present invention are not limited to payment services using payment cards and other payment mechanisms may be employed within the scope of embodiments.

Transaction information is communicated by the payment card reader at the offline location 310 to the payment service 308, for instance, through a transaction network. The transaction information is associated with the user's account at the payment service 308. Additionally, the payment service 308 may identify the offline activity as corresponding with offer information received from the tracking service 306.

The payment service 308 communicates information regarding the offline activity to the tracking service 306. The information may identify the user and indicate the offer for which the offline activity was completed. In some embodiments, the payment service 308 may provide more detailed information, such as the type of offline activity, information regarding a product or service purchased, a purchase price, the offline location 310, and/or a time/date of the offline activity. The tracking service 306 associates the information regarding the offline activity received from the payment service with information regarding the online activity for the user device 304.

Referring now to FIG. 4, a flow diagram is provided illustrating a method 400 for tracking a user's online activity and providing information regarding the online activity to a payment service in accordance with an embodiment of the present invention. Initially, as shown at block 402, a user's online activity is tracked by a tracking service, such as the tracking service 204 of FIG. 2. In embodiments, the tracking service tracks information regarding the user's interaction with advertisements presented during the online activity. For instance, the tracking service may track information regarding advertisements presented to the user, a number of times particular advertisements are presented to the user, advertisements a user hovered over, and advertisements selected by the user. In some embodiments, the tracking service may also track other information describing the user's online activity, such as, for instance, web pages viewed, search queries submitted, search results selected, and time/date information. As noted previously, a variety of approaches may be employed to track the user's online activity.

As shown at block 404, offers associated with advertisements presented to a user during the online activity are identified. The offers may include rebates and/or incentives that may be conditionally provided to the user based on some activity performed by the user. Information regarding offers corresponding with advertisements presented to the user are stored, as shown at block 406. In various embodiments of the present invention, offers may be identified and/or information regarding such offers may be stored based on one or more requirements. These requirements for a given advertisement may typically be defined by an advertiser associated with that advertisement. For instance, in some cases, an offer may be identified and/or stored for the user when the corresponding advertisement is simply presented to the user. In other cases, an offer may be identified and/or stored for the user after the advertisement has been presented to the user a minimum number of times. In further cases, an offer may be identified and/or stored for the user when the user hovers over the corresponding advertisement. In still further cases, an offer may be identified and/or stored when the user selects the corresponding advertisement.

In some embodiments, in addition to storing information regarding offers, other information regarding the user's online activity may be tracked and stored, such as shown at block 408. Generally, any of a variety of different information regarding a user's online activities may be tracked and stored. By way of example only and not limitation, this information may include web pages viewed by the user, search queries issued by the user, search results selected by the user, and/or time/date information for online activity. Additionally, the tracking service and/or other associated service may store specifics regarding the advertisement corresponding with the offer. For instance, an advertiser may associate a similar offer with a variety of different advertisements. The tracking service and/or other associated service could identify and store which advertisement was viewed and/or selected by the user to receive the offer.

As shown at block 410, information identifying the user and an offer now associated with the user is sent to a payment service, such as the payment service 208 of FIG. 2. The user identifying information may be a unique user identifier, although other identifying information may be employed to identify the user in embodiments of the present invention. Additionally, the offer identifying information may be a unique offer identifier, although other identifying information may be employed to identify the offer in embodiments of the present invention.

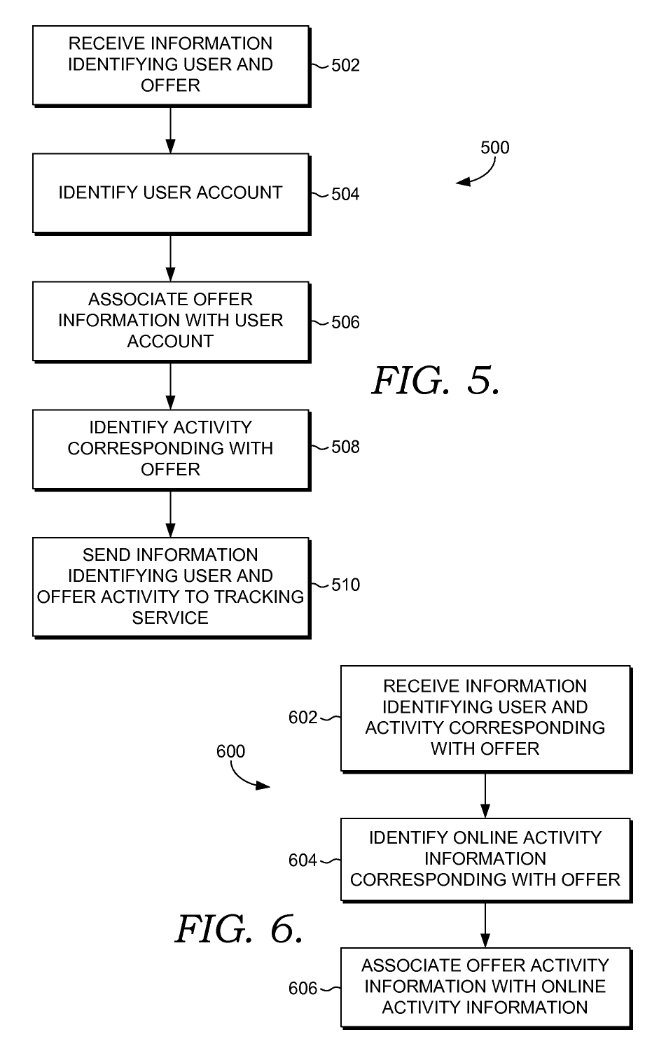

Turning to FIG. 5, a flow diagram is provided illustrating a method 500 for receiving offer information for a user at a payment service and identifying the occurrence of user activity that is associated with the offer in accordance with an embodiment of the present invention. As shown at block 502, information identifying a user and an offer is received at a payment service, such as the payment service 208 of FIG. 2. Generally, the information may be received from a tracking service, such as the tracking service 206 of FIG. 2, and/or from another associated service, via a method such as that described above with reference to FIG. 4.

Based on the received information identifying the user, a user account with the payment service is identified, as shown at block 504. Generally, the user identifying information may be a unique user identifier, although other identifying information may be employed in embodiments of the present invention. At block 506, the offer information is associated with the user account at the payment service. The offer information may be a unique offer identifier, which may be associated with the user account, although other identifying information may be employed in embodiments of the present invention.

As shown at block 508, activity corresponding with the offer is identified. The activity includes some activity performed by the user that is identified through the use of a payment card or other payment mechanism for the payment service. In some embodiments, the activity comprises offline activity performed by the user in an offline setting. For instance, the offline activity may be a purchase at a retail store using the payment card. In other cases, a user may perform offline activity other than a purchase, which may be recognized by reading the user's payment card at the offline location to identify completion of the activity. For example, a user may test drive a car at a automobile dealer, and the automobile dealer may read the user's payment card to allow the system to recognize that the user has completed the test drive. When the user's payment card is read at an offline location, information is provided to the payment service and associated with the user's account. Using this information, the payment service may identify that offline activity corresponding with the offer has been performed.

After completion of the offer activity, the payment service sends information identifying the user and the offer activity to the tracking service or another associated service, as shown at block 510. In some embodiments, the information identifying the offer activity may simply be information identifying the offer, such as a unique offer identifier. In other embodiments, the information may provide more detail information regarding the activity. By way of example only and not limitation, the information may identify the location of the activity, the time/date of the activity, and/or specifics of a product/service purchased.

Referring to FIG. 6, a flow diagram is provided illustrating a method 600 for a tracking service or other associated service to receive information regarding activity completed for an offer and to associate the offer activity information with online activity information. As shown at block 602, information identifying a user and activity corresponding with an offer is received at a tracking service, such as the tracking service 206 of FIG. 2, or another associated service. Generally, the information may be received from a payment service, such as the payment service 208 of FIG. 2, via a method such as that described above with reference to FIG. 5.

The received information may include a unique user identifier to identify the user, although other ways of identifying the user may be employed in some embodiments. Additionally, the information may identify the offer for which activity has been completed. The offer may be identified using a unique offer identifier, although other ways of identifying the offer may be employed in some embodiments of the present invention. In some embodiments, the receiving information may include details of the activity completed for the offer. For instance, the information may include a location at which the activity was performed, a time/date of the activity, and/or specifics regarding a particular product/service purchased by the user.

Based on the user identifying information and the offer identifying information, online activity information corresponding with the offer is identified, as shown at block 604. The information for the activity completed for the offer may then be associated with the online activity information, as shown at block 606.

As can be understood, embodiments of the present invention provide services for tracking online activity including offers extended to users through online advertising and using a payment service to identify performance of activities (including offline activities in some embodiments) associated with the offers and the online activity. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer-storage media having computer-useable instructions embodied thereon for performing a method comprising:
tracking online activity for a user;
identifying an offer associated with an advertisement presented during the online activity, the offer extending at least one of a rebate and an incentive to the user in exchange for the user performing a desired activity;
storing information regarding the offer;
sending information regarding the user and the offer to a payment service;
receiving information from the payment service regarding performance of the desired activity by the user; and
associating the information regarding performance of the desired activity by the user with the information regarding the offer.

2. The one or more computer-storage media of claim 1, wherein the online activity comprises at least one of web browsing, instant messaging, web searching, and emailing.

3. The one or more computer-storage media of claim 1, wherein the information regarding the offer is stored and sent to the payment service based on a determination of at least one of the following: the user has viewed the advertisement a predetermined number of times; the user has selected the advertisement; and the user has hovered over the advertisement.

4. The one or more computer-storage media of claim 1, wherein the method further comprises storing information regarding the online activity in addition to the information regarding the offer.

5. The one or more computer-storage media of claim 4, wherein the information regarding the online activity stored comprises one or more of the following: a web page viewed by the user, a search query submitted by the user, and a search result selected by the user.

6. The one or more computer-storage media of claim 4, wherein the method further comprises associating the information regarding performance of the desired activity by the user with the information regarding the online activity.

7. The one or more computer-storage media of claim 1, wherein sending information regarding the user and the offer to the payment service comprises sending a user identifier identifying the user and an offer identifier identifying the offer.

8. The one or more computer-storage media of claim 1, wherein the performance of the desired activity comprises performance of offline activity.

9. The one or more computer-storage media of claim 1, wherein the method further comprises providing at least one of the rebate and the incentive to the user for completing the desired activity associated with the offer.

10. The one or more computer-storage media of claim 1, wherein the method further comprises providing information regarding performance of the desired activity associated with the offer to an advertiser associated with the advertisement.

11. One or more computer-storage media having computer-useable instructions embodied thereon for performing a method comprising:
receiving information identifying the user and an offer associated with an advertisement presented to the user during online activity of the user, the information identifying the user and the offer being received at a payment service, wherein the offer extends at least one of a rebate and an incentive to the user in exchange for the user performing a desired activity; and
identifying performance of the desired activity associated with the offer, the performance of the desired activity including use of a payment mechanism associated with the payment service.

12. The one or more computer-storage media of claim 11, wherein the method further comprises providing information regarding performance of the desired activity to a service allowing the information regarding performance of the desired activity to be associated with information regarding the online activity.

13. The one or more computer-storage media of claim 11, wherein the information identifying the user and the offer comprises a user identifier identifying the user and an offer identifier identifying the offer.

14. The one or more computer-storage media of claim 11, wherein the performance of the desired activity comprises performance of offline activity.

15. The one or more computer-storage media of claim 11, wherein the method further comprises providing at least one of the rebate and the incentive to the user for completing the desired activity associated with the offer.

16. The one or more computer- storage media of claim 11, wherein the method further comprises providing information regarding performance of the desired activity associated with the offer to an advertiser associated with the advertisement.

17. A computerized system comprising:
one or more servers for tracking online activity for a user to identify an offer associated with an advertisement presented to the user, the offer extending a rebate or an incentive to the user in exchange for the user performing a desired activity, the one or more servers storing information regarding the online activity including the offer; the one or more servers also communicating information regarding the user and the offer to a payment service that facilitates payments using payment cards, wherein the payment service identifies offline activity performed by the user using a payment card that corresponds with the desired activity and communicates information regarding the offline activity to the one or more servers, and wherein the one or more servers associate the information regarding the offline activity with the information regarding the online activity.

18. The computerized system of claim 18, wherein the online activity comprises at least one of web browsing, instant messaging, web searching, and emailing.

19. The computerized system of claim 17, wherein the offline activity comprises a purchase at a retail store using the payment card.

20. The computerized system of claim 17, wherein the one or more servers facilitate providing the rebate or the incentive to the user for completing the desired activity associated with the offer.
